(19) United States
(12) Patent Application Publication
(10) Pub. No.: US 2013/0338851 A1
(43) Pub. Date: Dec. 19, 2013

(54) Automatic Accident Analysis

(71) Applicants: Maurice Lynch, Mountmellick (IE); Fearghal O'Hare, Belfast (IE)

(72) Inventors: Maurice Lynch, Mountmellick (IE); Fearghal O'Hare, Belfast (IE)

(21) Appl. No.: 13/993,441

(22) PCT Filed: Dec. 2, 2011
(86) PCT No.: PCT/US11/62982

§ 371 Date: Jun. 12, 2013

(51) Int. Cl. G06F 17/00

(52) U.S. Cl. CPC G06F 17/00
USPC 701/1

(57) ABSTRACT

In accordance with some embodiments, an automatic detector may detect characteristics of a vehicular crash and use those characteristics to project the nature of injuries to the driver and/or passengers within the vehicle. This information may be used by emergency room personnel to expedite the diagnosis of injuries.

### BACKGROUND

This relates generally to detecting characteristics of vehicular accidents.

Black boxes are commonly carried on aircraft in order to obtain information from electronic systems prior to an airplane crash. Generally, the purpose of these black boxes is to attempt to assess why the plane crashed.

Motor vehicles may have crash detection systems, including those used to activate airbags. Here, the crash detection system detects the severity of the crash and determines whether or not to deploy the airbags.

### BRIEF DESCRIPTION OF THE DRAWINGS

FIG. 1 is a schematic depiction for one embodiment of the present invention; and

FIG. 2 is a flow chart for one embodiment of the present invention.

### DETAILED DESCRIPTION

In accordance with some embodiments, an automatic detector may detect characteristics of a vehicular crash and use those characteristics to project the nature of injuries to the driver and/or passengers within the vehicle. This information may be used by emergency room personnel to expedite the diagnosis of injuries.

Typically such a system is installed in a motor vehicle such as a car, a truck, a motorcycle, a boat, a train or an airplane.

The system may be integrated into existing onboard computer systems in some embodiments. In other embodiments the system may communicate with such onboard computer systems, for example by accessing a vehicular controller area network (CAN) bus. In still other embodiments the system may be wholly independent of such existing onboard computer systems. For example, the system may be a mobile device such as a cellular telephone, tablet computer or a mobile Internet device.

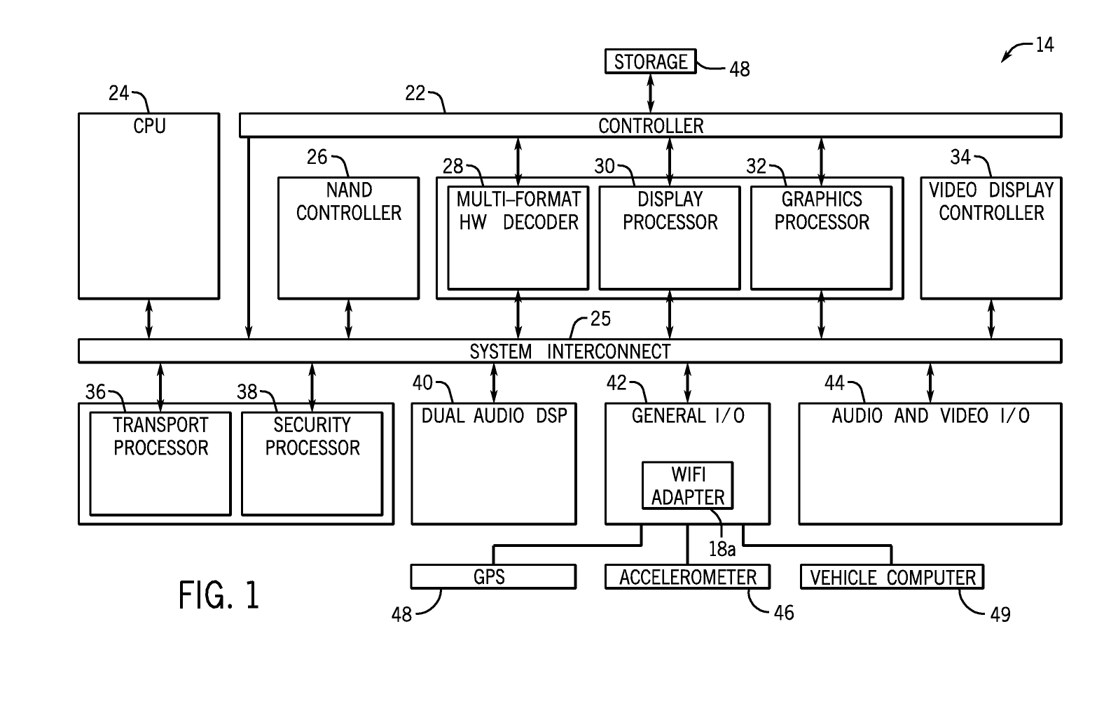

Referring to FIG. 1, one embodiment of the processor-based system 14 is depicted, but many other architectures may be used as well. The architecture depicted in FIG. 1 corresponds to the CE4100 platform, available from Intel Corporation. It includes a central processing unit 24, coupled to a system interconnect 25. The system interconnect is coupled to a NAND controller 26, a multi-format hardware decoder 28, a display processor 30, a graphics processor 32, and a video display controller 34. The decoder 28 and processors 30 and 32 may be coupled to a controller 22, in one embodiment.

The system interconnect may be coupled to transport processor 36, security processor 38, and a dual audio digital signal processor (DSP) 40. The digital signal processor 40 may be responsible for decoding the incoming video transmission. A general input/output (I/O) module 42 may, for example, be coupled to a wireless adaptor, such as a WiFi adaptor 18a. An accelerometer 46 may detect sudden acceleration or deceleration. A global positioning system (GPS) sensor 48 may also be provided. The general input/output may also receive information from a vehicular computer system 49. Also coupled to the system interconnect 25 is an audio and video input/output device 44. This may provide decoding video output and may be used to output video frames or clip in some embodiments.

The connection from the vehicle computer may be wired or wireless. For example, a wireless connection may be used when the system 14 is entirely separate from the vehicle, as may be the case for example, if the system 14 is a cellular telephone.

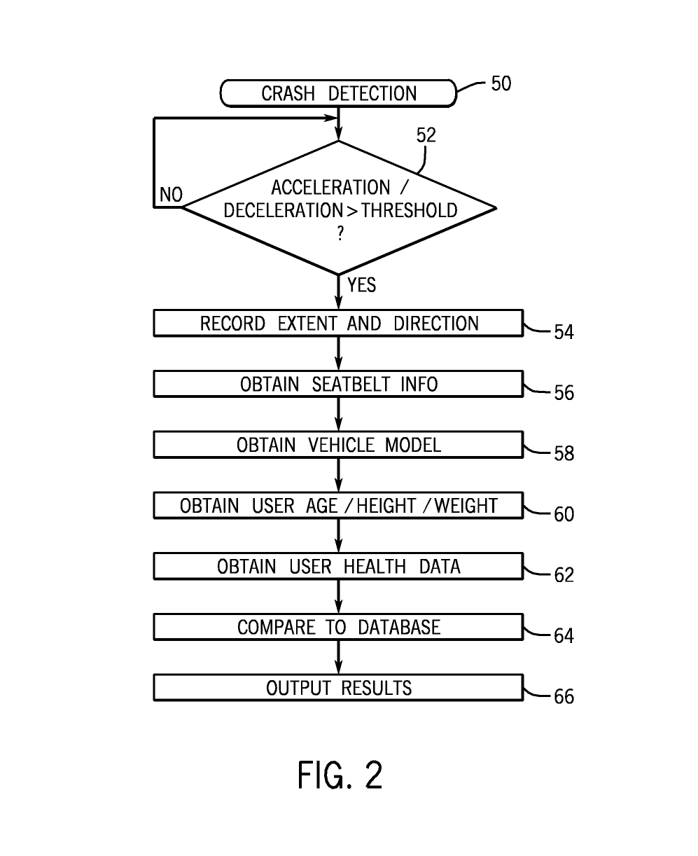

Referring to FIG. 2, a sequence 50 may be used in connection with the hardware depicted in FIG. 1, in some embodiments, in order to analyze the characteristics of a vehicular accident and to use those characteristics to predict the nature of likely injuries.

The sequence may be implemented in software, firmware, and/or hardware. In software and firmware embodiments, the sequence may be implemented by computer readable instructions stored in a non-transitory computer readable medium, such as a magnetic, optical, or semiconductor storage. For example, in one embodiment, the sequence may be stored in the storage 48.

Initially, a check at diamond 52 determines whether an acceleration or deceleration, detected by the accelerometer 46, is greater than a threshold. As one example, the threshold may be ±10 meters per second squared. If the acceleration or deceleration exceeds that threshold, indicating that an accident of sufficient severity has occurred, the extent and direction of the collision may be recorded, as indicated in block 54. Namely, the acceleration or deceleration may be recorded, as well as the direction of that acceleration or deceleration.

The vehicle's current velocity may also be stored. The current velocity may be obtained by sensors (not shown) or from the vehicular computer 49.

In addition, the location of the accident may be recorded by trapping global positioning system coordinates, again, through the vehicular computer 49 or a GPS device 48, as examples.

In some embodiments, information may be obtained automatically about whether seatbelts were in use, as indicated in block 56. This information may also be obtained from the vehicular computer 49. An electrical connection can be made up when the seatbelts are in position and whether or not the seatbelt has been fastened may be detected. Most modern vehicles now detect whether or not the seatbelts have been activated and, if not, issue an alarm. Thus, the information about seatbelt activation generally is obtainable from the vehicular computer 49 at the time of the accident.

In some embodiments, it may also be desirable to obtain information about the vehicle model, as indicated in block 58. This may be obtained from the vehicle computer 49 in some embodiments. Alternatively, the information about the vehicle may be acquired during an initial setup phase, in some embodiments. For example, a user may be prompted by a graphical user interface to enter various information into text entry fields in a graphical user interface.

In some embodiments, the user's age, height, and weight may be acquired, as indicated in block 60. Again, this can be acquired in a setup stage, in some embodiments using a graphical user interface for example provided on a display (not shown).

Next, user health data may be obtained, as indicated in block 62. This information may also be obtained in a setup mode, as well. Information about user physical conditions may also be useful in diagnosis. For example, if the user has a heart problem, emergency personnel may be prompted to monitor any heart issues precipitated by the stress of the accident.

Finally, in block 64, the information that has been collected about the accident, the vehicle, and the user may be compared to a database of information about the likely consequences of an accident of a given severity, given direction and, in some cases, under certain circumstances, including whether a seatbelt was fastened. The database may also correlate to vehicle models and various user characteristics. Using that database, the nature of the likely injuries may be projected. For example, in one embodiment, the ten most likely injuries or physical conditions to look for may be outputted at block 66. The idea is that this checklist may facilitate quick evaluation either by emergency personnel in route to the hospital or, ultimately, in the hospital, by the attending physicians.

The information collected by the system may be conveyed to emergency personnel or hospital emergency personnel in a number of different ways. In one embodiment, a removable memory card may be provided and may be extracted by emergency personnel and loaded into an appropriate computer in order to obtain the results of the analysis performed by the system. For example, the output from the system may be extracted from such a card. As another embodiment, a display be included which may simply be viewed by emergency personnel at the scene to determine information about the likely injuries. As still another possibility, the information developed by the system in its raw format or with projected physical conditions may be obtained wirelessly through a short range radio transmission system.

Thus, emergency personnel with appropriate receivers can receive this information and store it for their own use and for provision to emergency room personnel. As still another possibility, the information that is obtained by the system may automatically be transmitted for example by an automatic satellite radio transmission, to an emergency telephone center which collects information of this type. Based on the information that is collected and the location of the vehicle, the center may convey the information, for example via telephone call, to the closest emergency room. In cases in where this system is resident upon the user's own personal computer, such as a cellular telephone, the information may simply be extracted from the user's own display and used by emergency personnel at the scene and emergency room personnel thereafter.

The availability of the medical information may be broadcast via wireless signals in one embodiment. Alternatively or in addition, audible announcements may be provided as well to alert responders to the availability of information about the user's condition. For example, the system may periodically indicate, via speech generation, “Medical Information Available Here.”

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
automatically detecting information about the nature of a vehicular collision; and
using a computer processor to predict possible injuries based on the information.

2. The method of claim 1 including detecting the extent of an acceleration or deceleration.

3. The method of claim 2 including detecting whether the collision resulted in an acceleration or deceleration above a threshold.

4. The method of claim 2 including matching information about likely inquiries for a given level of acceleration or deceleration.

5. The method of claim 2 including determining the direction of acceleration or deceleration.

6. The method of claim 1 including determining using a device attached to a vehicle.

7. The method of claim 1 including determining using a mobile device independent of the vehicle.

8. The method of claim 7 including using a cellular telephone to determine said information.

9. The method of claim 1, including automatically communicating said information to an emergency responder.

10. A non-transitory computer readable medium storing instructions to enable a computer to:
detect information about the extent of a vehicular collision; and
use the information to predict possible injuries.

11. The medium of claim 9 further storing instructions to detect the extent of an acceleration or deceleration.

12. The medium of claim 10 further storing instructions to detect whether the collision resulted in an acceleration or deceleration above a threshold.

13. The medium of claim 10 further storing instructions to match information about likely inquiries for a given level of acceleration or deceleration.

14. The medium of claim 10 further storing instructions to determine the direction of acceleration or deceleration.

15. The method of claim 9 further storing instructions to determine using a device attached to a vehicle.

16. The medium of claim 9 further storing instructions to determine using a mobile device independent of the vehicle.

17. The medium of claim 15 further storing instructions to use a cellular telephone to determine said information.

18. The medium of claim 9 further storing instructions to communicate the information to an emergency responder.

19. An apparatus comprising:
a processor to detect information about the nature of a vehicular collision and to use the information to predict possible injuries; and
a storage coupled to said processor.

20. The apparatus of claim 17, said processor to detect the extent of an acceleration or deceleration.

21. The apparatus of claim 18, said processor to detect whether the collision resulted in an acceleration or deceleration above a threshold.

22. The apparatus of claim 18, said processor to match information about likely inquiries for a given level of acceleration or deceleration.

23. The apparatus of claim 18, said processor to determine the direction of acceleration or deceleration.

24. The apparatus of claim 17, wherein said apparatus is part of a vehicle.

25. The apparatus of claim 17, wherein said apparatus is a mobile device independent of the vehicle.

26. The apparatus of claim 23 wherein said apparatus is a cellular telephone.

27. The apparatus of claim 15 further said apparatus to automatically communication said information to an emergency responder.
